(19) United States
(12) Patent Application Publication
(10) Pub. No.: US 2026/0159099 A1
(43) Pub. Date: Jun. 11, 2026

(54) SYSTEMS, METHODS, AND APPARATUSES FOR VEHICLE PERSONALIZATION

(71) Applicant: Sonatus, Inc., Sunnyvale, CA (US)

(72) Inventors: Yu Fang, Palo Alto, CA (US); Thurston Zhu, San Francisco, CA (US); Giridhar Akila Dhakshinamoorthy, Sunnyvale, CA (US); Yixiang Chen, Palo Alto, CA (US)

(21) Appl. No.: 19/359,078

(22) Filed: Oct. 15, 2025

Related U.S. Application Data
(63) Continuation of application No. PCT/US2024/059014, filed on Dec. 6, 2024.
(60) Provisional application No. 63/606,980, filed on Dec. 6, 2023.

(51) Int. Cl. B60W 50/00

(52) U.S. Cl. CPC B60W 50/0098; B60W 2050/0083; B60W 2554/406; B60W 2555/20; B60W 2556/50

(57) ABSTRACT

A vehicle control system includes a controller having multiple coordinated circuits. A context analysis circuit interprets driving context and environmental condition data to determine a prioritized sequence of actions based on safety, efficiency, or user-defined preferences. A sequence management circuit generates an ordered action plan according to current driving conditions, while a dependency management circuit dynamically adjusts the plan based on inter-system dependencies or operating requirements. A sequence execution circuit implements the ordered plan by transmitting action commands to vehicle endpoints, automatically updating the action order in response to detected conditions.

### CLAIM TO PRIORITY

This application claims priority to and is a bypass continuation of International Patent Application No. PCT/US2024/059014, filed Dec. 6, 2024, and entitled SYSTEMS, METHODS, AND APPARATUSES FOR VEHICLE PERSONALIZATION (SONA-0021-WO), published as WO 2025/122963.

International Patent Application No. PCT/US2024/059014 claims the benefit of the following provisional application, which is hereby incorporated by reference in its entirety: U.S. Provisional Patent Application Ser. No. 63/606,980, filed Dec. 6, 2023, and entitled “SYSTEMS, METHODS, AND APPARATUSES FOR VEHICLE PERSONALIZATION” (SONA-0021-P01).

### BACKGROUND

Modern vehicles are increasingly required to provide a high degree of customization, enabling configurations that cater to individual preferences, environmental conditions, and distinct driving scenarios. Such customizations extend beyond basic comfort features to include personalized settings for climate control, seat positioning, lighting, and audio. However, the implementation of these customized configurations poses significant challenges. Conventional methods for modifying or updating vehicle settings typically rely on either direct physical access or intricate software updates. These methods not only incur considerable costs but also present potential operational risks, as they often require vehicle downtime and impose the possibility of system failure if updates are interrupted. Further, previously available methods for modifying or updating vehicle settings require the involvement of a highly sophisticated user, and specific knowledge about the vehicle, end points, and data thereon, and generally require a full engineering team to implement and plan the deployment of a feature.

The demand for increasingly connected and multifunctional vehicles exacerbates the strain on users, who must manage a complex array of customizable settings and features. As SDVs integrate a growing range of devices, sensors, and actuators, users face heightened challenges in navigating and adjusting these settings effectively.

### SUMMARY

In some aspects, the techniques described herein relate to a system, including: a vehicle having a network including a plurality of end points; a controller, including: an interface circuit structured to interpret a customization sequence description and a trigger condition description, wherein the customization sequence description includes a specific order of actions, and the trigger condition description includes one or more environmental, location-based, or time-based conditions; a sequence management circuit structured to provide a trigger detection plan and a sequence execution plan in response to the customization sequence description and the trigger condition description; and a sequence execution circuit structured to determine a trigger event value in response to the trigger detection plan, and to provide a customization command in response to the trigger event value and the sequence execution plan; wherein an end point of the plurality of end points is responsive to the customization command to implement an automated vehicle response based on the customization sequence description and detected conditions.

In some aspects, the techniques described herein relate to a system, wherein the customization sequence description includes prioritization parameters that adjust a first set of settings to prioritize driver comfort over passenger comfort.

In some aspects, the techniques described herein relate to a system, wherein the trigger condition description includes at least one of a date, a time, or a calendar event.

In some aspects, the techniques described herein relate to a system, wherein the interface circuit is further structured to interpret a plurality of customization sequence descriptions, wherein each customization sequence description is associated with different driving scenario.

In some aspects, the techniques described herein relate to a system, wherein the sequence management circuit is configured to dynamically modify an order of actions in the customization sequence description in response to real-time data.

In some aspects, the techniques described herein relate to a system, wherein the sequence execution circuit includes a feedback mechanism that generates a notification of successful application of each action in the customization sequence description, and provides alerts for any actions that could not be completed.

In some aspects, the techniques described herein relate to a system, wherein the end points of the plurality of end points include sensors for detecting in-cabin conditions such as temperature, humidity, and air quality, and wherein the customization sequence description incorporates these conditions to automatically adjust in-cabin climate control settings.

In some aspects, the techniques described herein relate to a system, wherein the interface circuit is further configured to interpret conditional actions within the customization sequence description that activate if a passenger characteristic is detected by the system, wherein the passenger characteristic includes at least one of a height, weight, or age.

In some aspects, the techniques described herein relate to a system, further including a cloud-based storage module configured to save the customization sequence description, allowing a user to access and apply the customization sequence description across multiple vehicles.

In some aspects, the techniques described herein relate to a system, wherein the sequence execution circuit incorporates machine learning algorithms that adjust the customization sequence description over time based on a user's behavior patterns and historical preferences.

In some aspects, the techniques described herein relate to a system, wherein the trigger condition description includes geographic-based conditions that activate specific customization sequences when the vehicle enters or exits predefined areas.

In some aspects, the techniques described herein relate to a method for implementing ordered vehicle personalization, including: receiving, at a vehicle controller, a user-defined sequence of vehicle settings, wherein the user-defined sequence specifies: a plurality of vehicle settings, and an order in which the plurality of vehicle settings are to be implemented; storing the user-defined sequence in a memory; detecting a sequence initiation event; retrieving, in response to detecting the sequence initiation event, the user-defined sequence from the memory; executing the user-defined sequence by: implementing each vehicle setting in the specified order; waiting for confirmation of successful implementation of each vehicle setting before implementing a next vehicle setting in the sequence; and generating a completion notification upon implementing all vehicle settings in the sequence; and storing implementation data including a timestamp of the sequence execution, success or failure status of each implemented setting, and any modifications made during the implementation.

In some aspects, the techniques described herein relate to a method, further including: detecting occupant presence in multiple zones of the vehicle; determining occupant characteristics including: driver or passenger status, age category, physical characteristics, or stored preferences; modifying the sequence execution based on: occupant location within the vehicle, occupant priority levels, or occupant-specific comfort requirements; and implementing zone-specific settings according to the modified sequence.

In some aspects, the techniques described herein relate to a method, further including: detecting presence of a child passenger; modifying the sequence to prioritize at least one of rear passenger zone climate control, child safety lock activation, rear sunshade deployment, rear entertainment system activation, or rear lighting adjustments; monitoring child zone conditions; and adjusting settings to maintain predetermined child comfort parameters.

In some aspects, the techniques described herein relate to a method, wherein executing the user-defined sequence includes: determining current vehicle context including geographical location, jurisdiction-specific requirements, altitude-based parameters, time of day, or current weather conditions; selecting a context-appropriate sequence variation; and adjusting implementation timing based on the current vehicle context.

In some aspects, the techniques described herein relate to a method, further including: maintaining multiple sequence variations for different scenarios including: daily commute sequences; long-journey sequences; school transport sequences; sport activity sequences; and family trip sequences; automatically selecting appropriate sequences based on at least one of calendar data, location patterns, time patterns, or detected occupants.

In some aspects, the techniques described herein relate to a system for automated vehicle configuration, including: a vehicle having a network including a plurality of end points; a controller, including: a context analysis circuit structured to interpret driving context data and environmental condition data, wherein the context analysis circuit is configured to determine a prioritized sequence of actions based at least on one of safety, efficiency, or user-defined preferences; a sequence management circuit structured to generate an ordered action plan in response to the prioritized sequence of actions, wherein the ordered action plan arranges the actions based on current driving conditions; a dependency management circuit structured to dynamically adjust an order of actions in the ordered action plan based on dependencies between vehicle systems or operating requirements; and a sequence execution circuit structured to execute the ordered action plan by sending action commands to one or more of the plurality of end points, wherein an order of the prioritized sequence of actions is automatically adjusted based on detected conditions.

In some aspects, the techniques described herein relate to a system, wherein the sequence execution circuit is further structured to adjust the order based detection of at least one of nighttime driving or icy road conditions.

In some aspects, the techniques described herein relate to a system, wherein the context analysis circuit further includes a sensor interface configured to receive input from sensors detecting external lighting, road surface conditions, traffic, and weather.

In some aspects, the techniques described herein relate to a system, wherein the sequence management circuit is further structured to prioritize actions that enhance visibility by at least one of activating adaptive headlights or adjusting dashboard lighting.

In some aspects, the techniques described herein relate to a system, wherein the dependency management circuit is configured to detect interdependencies among vehicle systems.

In some aspects, the techniques described herein relate to a system, wherein the context analysis circuit is further structured to incorporate user-defined preferences for non-critical.

In some aspects, the techniques described herein relate to a system, wherein the dependency management circuit reorders actions in the ordered action plan to ensure that actions related to vehicle stability and control are executed before in-cabin settings.

In some aspects, the techniques described herein relate to a system, wherein the sequence execution circuit is further configured to delay or modify the execution of actions based prioritizing actions that optimize fuel efficiency during congested driving conditions.

In some aspects, the techniques described herein relate to a system, wherein the context analysis circuit includes a geolocation interface configured to adjust the prioritized sequence of actions when the vehicle enters school zones or construction areas.

In some aspects, the techniques described herein relate to a system, wherein the sequence management circuit is further structured to automatically update the ordered action plan based on real-time data from external data sources.

In some aspects, the techniques described herein relate to a system for activating vehicle settings, including: a mobile device operatively connected to a vehicle network, wherein the mobile device includes a user interface structured activate personalized vehicle settings; a vehicle access module structured to authenticate a user for activation of the personalized vehicle settings, a settings activation module configured to: enable the user to selectively activate one or more personalized vehicle settings; transmit the selected settings from the mobile device to the vehicle remotely; and provide feedback to the user on the mobile device or cloud platform confirming a successful application of settings; and a user access management module structured to assign different levels of settings access based on a role of the authenticated user.

In some aspects, the techniques described herein relate to a system, wherein the settings activation module is further configured for batch activation of settings across multiple vehicles in a fleet.

In some aspects, the techniques described herein relate to a system, wherein the user interface provides a “quick access” feature for frequently used settings, enabling users to activate specific pre-configured settings with a single action.

In some aspects, the techniques described herein relate to a system, wherein the vehicle access module enables role-based customization through a cloud-based server, allowing settings access and permissions to be managed remotely by fleet administrators or vehicle owners.

In some aspects, the techniques described herein relate to a system, wherein the user access management module provides restricted access to specific settings based on location.

In some aspects, the techniques described herein relate to a system for vehicle customization, including: an application interface configured to allow a user to generate profiles and playlists of personalized vehicle settings; a customization interface within the application interface, structured to: provide customization options applicable to a vehicle; adapt the customization options for supported settings for a vehicle model; detect and display the customization options relevant to the supported settings of the vehicle; a settings inference module configured to use a database of conversion settings, wherein settings saved for one vehicle can be inferred and adjusted for use in other vehicles based on vehicle parameters.

In some aspects, the techniques described herein relate to a system, wherein the settings inference module is configured to translate general seat position settings into specific seat coordinates by interpreting physical dimensions and adjustment range of a vehicle's seating system.

In some aspects, the techniques described herein relate to a system, wherein the settings inference module converts a general audio volume preference into specific speaker output levels by accounting for a number, placement, and acoustics of speakers within the vehicle.

In some aspects, the techniques described herein relate to a system, wherein the settings inference module adjusts mirror positioning settings by interpreting a general viewing angle preference and translating it into specific physical adjustments based on a location and range of a vehicle's mirrors.

In some aspects, the techniques described herein relate to a system, wherein the settings inference module interprets general climate control settings into specific air flow and temperature configurations based on a vehicle's cabin size, vent locations, or HVAC capabilities.

In some aspects, the techniques described herein relate to a system, wherein the settings inference module translates a general driving mode preference into specific configurations for throttle response, suspension stiffness, and steering sensitivity based on a physical specifications of a vehicle's drivetrain and handling systems.

In some aspects, the techniques described herein relate to a system, wherein the settings inference module interprets general headrest height preferences into specific height adjustments by considering seat design and adjustment limits for headrest positioning in the vehicle.

In some aspects, the techniques described herein relate to a system, wherein the settings inference module converts a general air circulation preference into specific fan speed and vent direction adjustments.

In some aspects, the techniques described herein relate to a system, wherein the settings inference module interprets a general legroom preference into specific seat track adjustments based on available seat adjustment range and cabin space specific to the vehicle model.

In some aspects, the techniques described herein relate to a vehicle customization system including: a processor; and a memory storing instructions that, when executed by the processor, cause the vehicle customization system to: receive, via a user interface, user input for generating vehicle setting profiles and playlists; store the vehicle setting profiles in a profile database; provide, via a customization interface, selectable vehicle customization options; receive vehicle identification data identifying a specific vehicle model; access, from a vehicle parameters database, supported customization parameters for the specific vehicle model; dynamically filter the selectable vehicle customization options based on the supported customization parameters; display, via the customization interface, the filtered vehicle customization options; receive user selections of customization options; access a settings conversion database storing vehicle-specific conversion parameters; generate, using the conversion parameters, converted vehicle settings by mapping selected customization options from a source vehicle model to corresponding settings for a target vehicle model; and transmit the converted vehicle settings to a vehicle control module of the target vehicle model.

In some aspects, the techniques described herein relate to a vehicle customization system, wherein the instructions further cause the vehicle customization system to: generate a user settings profile including: primary vehicle settings including at least one of seat position data, mirror position data, steering wheel position data, and display configuration data; and secondary vehicle settings including at least one of climate control parameters, audio system parameters, and lighting parameters; wherein the user settings profile is transferable between different vehicle models.

In some aspects, the techniques described herein relate to a vehicle customization system, wherein generating the converted vehicle settings includes: accessing, from the settings conversion database, vehicle-specific ranges for each customization parameter; determining whether any selected customization option exceeds a corresponding vehicle-specific range for the target vehicle model; and a automatically adjusting any selected customization option that exceeds its corresponding vehicle-specific range to fall within the vehicle-specific range.

In some aspects, the techniques described herein relate to a vehicle customization system, wherein the instructions further cause the vehicle customization system to: receive historical user preference data for multiple users across different vehicle models; train a machine learning model using the historical user preference data; and generate, using the trained machine learning model, predicted optimal settings for a target vehicle model based on user settings from a source vehicle model.

In some aspects, the techniques described herein relate to a vehicle customization system, wherein the instructions further cause the vehicle customization system to: establish a wireless communication link with a target vehicle; authenticate the wireless communication link using vehicle-specific security credentials; transmit the converted vehicle settings to the vehicle control module via the authenticated wireless communication link; and receive confirmation of successful implementation of the converted vehicle settings.

In some aspects, the techniques described herein relate to a vehicle customization system, wherein the instructions further cause the vehicle customization system to: monitor real-time vehicle sensor data during implementation of the converted vehicle settings; detect any safety-critical deviations in the implemented settings; and automatically adjust any safety-critical deviations to fall within predetermined safety parameters.

In some aspects, the techniques described herein relate to a vehicle customization system, wherein the vehicle setting profiles include: a default profile for normal driving conditions, an efficiency profile optimized for maximum fuel efficiency, a performance profile optimized for enhanced vehicle response, or a comfort profile optimized for passenger comfort.

In some aspects, the techniques described herein relate to a vehicle customization system, wherein the instructions further cause the vehicle customization system to: receive a request to merge settings from multiple vehicle setting profiles; identify overlapping settings between the multiple vehicle setting profiles; determine priority rules for resolving conflicts between overlapping settings; generate a merged profile by: selecting non-conflicting settings from each profile, applying the priority rules to select between conflicting settings, and validating the merged settings against vehicle-specific parameters; and store the merged profile in the profile database.

In some aspects, the techniques described herein relate to a vehicle customization system, wherein determining priority rules includes: assigning weight factors to settings based on: frequency of user adjustments, recency of settings modifications, user-designated setting priorities, or safety-critical parameters; and calculating a priority score for each conflicting setting based on the weight factors.

In some aspects, the techniques described herein relate to a vehicle customization system, wherein the instructions further cause the vehicle customization system to: receive a settings sharing request from a first user to share settings with a second user; verify sharing permissions associated with a profile of the first user; generate a shareable settings package by: filtering out personal identification data; removing vehicle-specific secure parameters; and converting remaining settings to a platform-independent format; and transmit the shareable settings package to the second user's profile.

In some aspects, the techniques described herein relate to a vehicle customization system, wherein the instructions further cause the vehicle customization system to: detect multiple users present in the vehicle; identify vehicle setting profiles for each detected user; calculate compromise settings by: identifying conflicting preferences between user profiles; applying weighting factors based on user seating positions; determining overlapping acceptable ranges for conflicting settings; and generating blended settings within the overlapping acceptable ranges; and implement the compromise settings in the vehicle.

In some aspects, the techniques described herein relate to a vehicle customization system, wherein the instructions further cause the vehicle customization system to: maintain version control of vehicle setting profiles by: storing timestamped snapshots of profile modifications; tracking sources of profile changes; maintaining a modification history for each setting; and enabling rollback to previous profile versions; and synchronize profile versions across multiple devices.

In some aspects, the techniques described herein relate to a system for capturing vehicle customization settings, including: a processor; and a memory storing instructions that, when executed by the processor, cause the system to: establish a communication link with a vehicle control system; monitor, in real-time, vehicle setting inputs received through physical controls of the vehicle; detect changes in vehicle settings initiated through the physical controls; capture, in response to detecting the changes, vehicle setting adjustment data including: an identifier of an adjusted vehicle setting; a value of the adjusted vehicle setting; and a timestamp of the adjustment; generate, via a user interface, a real-time display of the detected changes including: a visual indication of each adjusted vehicle setting; current values of the adjusted vehicle settings; and selectable options for managing the adjusted vehicle settings; receive, via the user interface, a user input selecting a management option for the adjusted vehicle settings; generate, based on the user input, a settings profile incorporating the captured vehicle setting adjustment data; and store the settings profile in a profile database.

In some aspects, the techniques described herein relate to a system, wherein the instructions further cause the system to: determine a user identity based on at least one of: a key fob identifier; a paired mobile device; a driver profile selection; or a seat position sensor; and associate the captured vehicle setting adjustment data with the determined user identity.

In some aspects, the techniques described herein relate to a system, wherein displaying the detected changes includes: generating a graphical user interface including: a real-time animation reflecting physical changes in the vehicle; numerical values of adjusted settings; textual descriptions of adjusted settings; and interactive controls for fine-tuning the adjusted settings.

In some aspects, the techniques described herein relate to a system, wherein the instructions further cause the system to: detect a trigger event including at least one of: a rapid sequence of multiple setting adjustments; a predefined combination of setting adjustments; a settings adjustment exceeding a threshold value; or a duration of continuous adjustment exceeding a time threshold; and in response to detecting the trigger event, automatically display the user interface with enhanced setting management options.

In some aspects, the techniques described herein relate to a system, wherein the instructions further cause the system to: categorize captured setting adjustments into: comfort settings, safety settings, performance settings, or convenience settings; assign priority levels to each category; and apply category-specific management rules when storing the settings profile.

In some aspects, the techniques described herein relate to a system, wherein the instructions further cause the system to: receive an input indicating completion of a settings adjustment session; generate a session summary including: a list of all adjusted settings; before and after values for each adjustment; estimated impact on vehicle performance; and suggested related settings for adjustment; display the session summary via the user interface.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts an example system for implementing customization sequences.

FIG. 2 depicts an example method for implementing ordered vehicle personalization.

FIG. 3 depicts an example system for implementing automated vehicle configurations sequences in a vehicle.

FIG. 4 is an example system for remote vehicle personalization through a mobile device operatively connected to a vehicle network.

FIG. 5 is an example system for implementing automated vehicle customization.

### DETAILED DESCRIPTION

Software-Defined Vehicles (SDVs) are vehicles whose functionalities, features, and performance capabilities are primarily governed by software rather than just hardware components. This software-centric design enables manufacturers to introduce features, upgrades, and optimizations throughout the vehicle's lifecycle. Unlike traditional vehicles, which rely on fixed physical components for functionality, SDVs provide flexibility by allowing software to define, control, and update various systems and settings.

SDVs offer a high degree of personalization, allowing drivers to customize and automate settings for features like climate control, seating, lighting, and driving modes. This personalization can also be dynamic, adapting automatically to driving conditions or driver preferences. Additionally, SDVs support over-the-air (OTA) updates, enabling remote delivery of new features, security patches, and performance improvements without requiring a visit to a dealership.

The high level of personalization, while valuable, can quickly become overwhelming for users, who may find it difficult to navigate and manage the countless options available. With the ability to customize nearly every aspect of the vehicle, users may spend significant time adjusting settings for different driving situations or preferences, making it challenging to fully leverage the vehicle's capabilities. This complexity is further amplified by the fact that different vehicles may offer distinct settings or employ different methods for configuring these settings, requiring users to learn and adapt to each system individually. Such inconsistency not only adds to the cognitive load but also reduces user satisfaction, as constant manual adjustments and adaptation detract from the convenience and ease-of-use that SDVs aim to provide.

Embodiments described herein provide solution that can manage settings based on user preferences, behavior, and real-time environmental conditions. By using artificial intelligence and machine learning, the vehicle can learn user patterns and preferences over time, gradually automating many of the routine adjustments. This approach simplifies the experience, enabling the vehicle to handle repetitive settings without requiring manual input.

Embodiments described herein incorporate “if-this-then-that” logic, where users can set conditions for certain settings to activate automatically. For instance, the vehicle might automatically switch to a quiet cabin mode when detecting a phone call or activate specific ADAS features in response to high-speed highway driving. By allowing users to create custom, conditional routines or even suggesting these based on observed behaviors, the system can reduce the burden of managing multiple settings manually.

Embodiments described herein may include a centralized, user-friendly interface, such as a mobile app or digital cockpit display, that organizes settings intuitively and provides recommendations for optimizing them. This interface could prioritize the most frequently used features and hide less relevant settings, reducing clutter and making it easier for users to access what they need quickly. In fleet or shared vehicle contexts, such solutions could also support profile-based customization, allowing multiple users to save unique preferences, which the vehicle automatically applies when each individual logs in.

Embodiments described herein provide users with the ability to define a specific sequence of actions or settings within a customizable routine, enabling them to personalize their vehicle experience in an exact order of their choosing. This user-defined sequence executes each action in the specified order, allowing for precise customization. These sequences can be designed to trigger based on various environmental conditions or personal preferences, with both the order of actions and the trigger conditions fully determined by the user. For instance, users can set preferences that consider passenger needs, such as prioritizing driver settings (e.g., directing cooler air to the driver) or focusing on passenger comfort (e.g., adjusting climate settings to quickly reach the desired temperature for a child passenger). Additionally, personalization sequences may activate automatically in response to specific times, calendar dates, external events (such as weather), vehicle location (including geography, physical location, jurisdiction, altitude, temperature, or humidity), and other operating conditions, ensuring that settings are applied in a context-appropriate order. This approach delivers a tailored experience that adapts seamlessly to varying contexts and driving environments.

Embodiments described herein can autonomously determine the optimal sequence of actions based on driving context or environmental conditions, prioritizing safety, and efficiency. For instance, during nighttime driving, it may automatically enable adaptive headlights, adjust dashboard lighting, and activate night-mode navigation in a prioritized order to enhance visibility and safety. The system can also re-order actions to ensure that essential features are engaged first; for example, if icy road conditions are detected, it might activate traction control and adjust speed settings before modifying less critical parameters like in-cabin ambiance. This sequencing adjusts dynamically based on dependencies, allowing the system to adapt to immediate driving needs.

Embodiments described herein allow users to create “playlists” of settings that encompass specific configurations for the vehicle environment, such as seat position, climate control, lighting, audio preferences, and drive modes. These playlists can be programmed to activate automatically based on various driving scenarios, including daily commutes, road trips, weather conditions, or time spent in the vehicle. Additionally, these playlists are stored in the cloud, allowing users to access their personalized settings seamlessly across any compatible vehicle within the system's ecosystem. This cloud-based storage provides flexibility and continuity, eliminating the need for users to manually reconfigure their preferences when switching between supported vehicles.

Embodiments described herein allow user to activate settings on a vehicle by scanning it with their phone, entering passcodes, or using the vehicle's VIN. Playlists can be created and managed through mobile apps or cloud platforms, allowing for remote activation of settings, such as preparing the vehicle before entering. Users also have the option to selectively apply only specific aspects of their playlist when sending it to a new vehicle. For instance, a user renting a vehicle for a short period might choose to activate climate control and driving mode preferences, while omitting long-term settings like media preferences. Once a playlist is remotely sent, users receive feedback confirming which settings were successfully applied and noting any settings that were skipped due to incompatibility or other limitations. In shared or fleet vehicles, access levels can vary; for example, a fleet manager might have full control over all settings, whereas individual drivers could have limited access to features like climate control and entertainment preferences. In rental fleets, these customization options may be available through a paywall feature.

Embodiments described herein provides an intuitive interface for creating profiles and playlists, offering general customization options that apply across any vehicle, such as setting default seat position, cabin temperature preferences, and favorite media sources (e.g., radio stations, playlists, and podcasts). The system intelligently recognizes and adapts to the unique features of each vehicle model, allowing users to tailor profiles specifically to individual vehicles. The interface identifies which features are supported by the vehicle and displays only relevant customization options, streamlining the setup process. Additionally, users receive real-time visual feedback on changes, such as previews of ambient lighting adjustments or driving mode configurations. The app can also infer settings for other vehicles based on those saved for a specific model. This is achieved through a database of conversion settings, such as seat position offsets and radio volume levels, using data on vehicle dimensions or predefined conversion factors to provide a seamless experience across different vehicles.

Embodiments described herein provide for unique customization interface that allows a user to use different vehicle interfaces to generate settings. Rather than solely relying on the app for customization, users can adjust settings directly within the vehicle in real time. The app then detects these changes and provides an interface displaying the recognized settings, offering options for users to save or modify them as desired. This approach allows for seamless customization without needing to navigate through the app initially, while still providing the flexibility to store and adjust settings as needed.

Certain aspects of the present disclosure include adjusting the routing of communications on a network, whether between separate devices on the network, or between a device on the network and an external device. Certain aspects of the present disclosure include applying configurations and/or policies to controllers of the vehicle, facilitating communication between end points of the vehicle, including between end points on different networks or different network zones, and between end points that utilize distinct data formatting, data rates, communication protocols, or the like. Without limitation to any aspect of the present disclosure, some tools that can be utilized to tactically implement certain operations herein, in combination with the present disclosure, and descriptions that can enhance understanding of some of the terminology used herein (e.g., policy, end point, external device, network protocol, network type, etc.) can be found in one or more of the following U.S. Patents or Patent Applications: U.S. application Ser. No. 17/027,167, filed 21 Sep. 2020, and entitled SYSTEM, METHOD, AND APPARATUS TO SUPPORT MIXED NETWORK COMMUNICATIONS ON A VEHICLE (SONA-0006-U01); U.S. application Ser. No. 17/027,187, filed 21 Sep. 2020, and entitled SYSTEM, METHOD, AND APPARATUS TO EXTRA VEHICLE COMMUNICATIONS CONTROL (SONA-0007-U01); U.S. application Ser. No. 17/195,589, filed 8 Mar. 2021, and entitled SYSTEM, METHOD, AND APPARATUS FOR MANAGING VEHICLE DATA COLLECTION (SONA-0010-U01); U.S. application Ser. No. 17/833,614, filed 6 Jun. 2022, and entitled SYSTEM, METHOD, AND APPARATUS FOR MANAGING VEHICLE DATA COLLECTION (SONA-0012-U01); and/or U.S. application Ser. No. 18/244,147, filed 8 Sep. 2023, and entitled SYSTEM, METHOD, AND APPARATUS TO EXECUTE VEHICLE COMMUNICATIONS USING A ZONAL ARCHITECTURE (SONA-0015-U01), each of which is incorporated herein by reference in the entirety for all purposes.

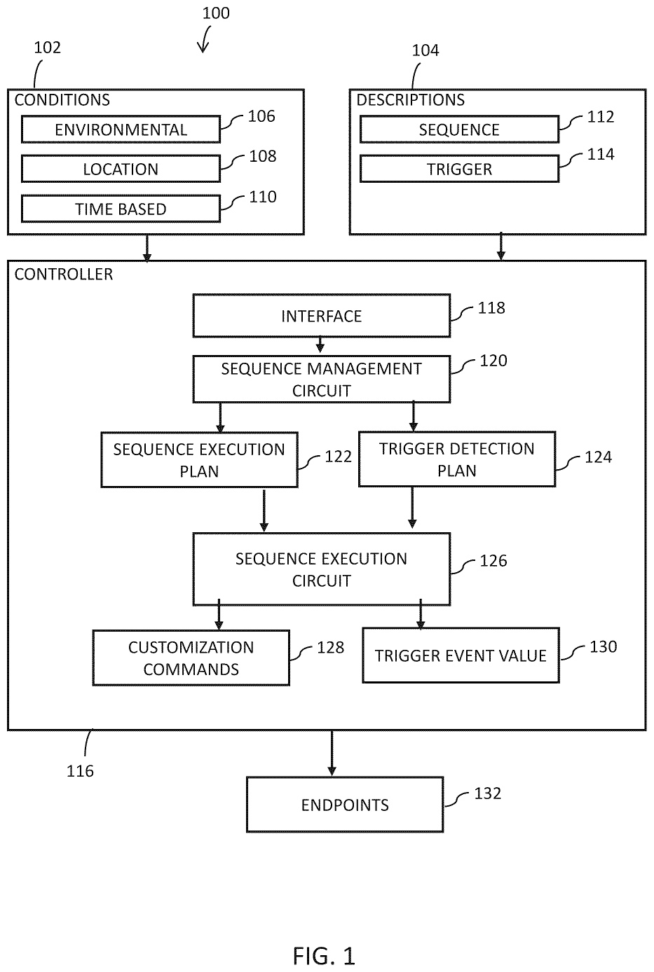

Referencing FIG. 1, an example system 100 for implementing ordered customization sequences in a vehicle is shown. The system 100 may implement and coordinate customization actions by controlling one or more end points 132 of a vehicle. The system includes a controller 116 having specialized circuits that work together to receive, process, and execute customized sequences of vehicle operations according to specific trigger conditions. In certain embodiments, customization actions are implemented by providing a policy, algorithm, or other command structure to one or more controllers on the vehicle, and/or to end points of the vehicle, where the policy, algorithm, or other command structure causes the customization actions to be executed according to the disclosure by the one or more controllers and/or end points of the vehicle.

End points, as utilized throughout the present disclosure, comprise any device, sensor, actuator, controller, or other component connected to the vehicle network that can either provide data to the system or respond to commands from the system. End points may be distributed across different network zones of the vehicle and may utilize different network protocols or communication methods.

Example and non-limiting end points include actuators (e.g., seat position motors, mirror adjustment mechanisms, heat/ventilation/air conditioning (HVAC) controls, door locks), sensors (e.g., temperature sensors, occupancy sensors, light sensors, speed sensors), controllers (e.g., body control modules, engine control units, transmission controllers), user interface devices (e.g., displays, buttons, touchscreens), communication devices (e.g., wireless transceivers, network gateways), entertainment systems (e.g., audio systems, rear seat entertainment displays), and the like.

End points may be categorized based on their primary function within the system. Input end points provide data or information to the system, such as sensors reporting vehicle state or operating conditions. Output end points receive and respond to commands from the system, such as actuators implementing vehicle responses. Some end points may function as both input and output devices, such as smart controllers that both provide state information and respond to commands. End points may further be characterized by their response capabilities. Certain end points may provide immediate responses to commands, while others may require sequential operations or have specific timing requirements. The system accounts for these varying response characteristics in the execution of customization sequences, ensuring proper coordination and timing of commands to different end points.

Without limitation to any other aspect of the present disclosure, the system supports communication with and control of end points regardless of their network location, protocol requirements, or response characteristics. This capability enables comprehensive vehicle customization sequences that can coordinate multiple end points across different vehicle systems and networks while maintaining proper sequence ordering and timing.

End points may be added, removed, or modified over the life of the vehicle, and the system supports dynamic discovery and configuration of end points to maintain proper operation as the vehicle configuration changes. This flexibility enables the system to adapt to vehicle modifications or upgrades while maintaining proper sequence execution capabilities. In certain embodiments, end points may be distributed on one or more networks and/or network zones, which may be separate physical networks (or zones) or virtual separate networks (or zones).

The system 100 includes an interface circuit 118. The interface circuit 118 is structured to process customization descriptions 104 that may include multiple actions or sequences, dependencies between actions, and/or specific ordering requirements. A customization sequence description 112, as utilized herein, defines an ordering of actions to be performed by the vehicle. The customization sequence description allows users to specify not only which actions should be performed but also the exact sequence, timing, and/or dependencies between these actions, and/or acceptable ranges and/or variances in the sequence, timing, and/or dependencies.

The sequence description 112 may include any combination of serial operations, parallel operations, conditional branches, and timing dependencies. For example, a sequence description may specify that seat positioning must complete before mirror adjustments begin, or that climate control settings should be adjusted simultaneously with seat heating activation. These ordering requirements are maintained by the system during execution while allowing for appropriate adjustments based on real-time vehicle conditions.

Example and non-limiting orderings within a customization sequence description include strictly serial operations where each action must complete before the next begins, parallel operations where multiple actions may execute simultaneously, conditional branching where the next action depends on the outcome of a previous action, time-based dependencies where specific delays or timing requirements exist between actions, state-based dependencies where certain vehicle conditions must be met between actions, and/or grouped operations where a set of related actions must complete before proceeding to the next group.

In certain embodiments, the customization sequence description may include priority designations for different actions within the sequence. These priorities help resolve potential conflicts when multiple sequences are active or when real-time conditions require adjustment of the execution order while maintaining essential ordering requirements.

The system supports sequence descriptions that may include nested operations, loops, and conditional execution paths. For example, a sequence might specify repeating certain actions until a condition is met, or executing different branches of the sequence based on detected vehicle conditions. The system maintains proper ordering within these complex structures while ensuring safe and efficient execution.

The customization sequence description may further specify timing requirements between actions. These timing specifications may include minimum delays between actions, maximum allowed execution times, or specific timing relationships between parallel operations.

In certain embodiments, the sequence description may include fallback or recovery operations that specify how the sequence should proceed if certain actions cannot be completed or if interruptions occur.

The interface circuit is structured to process trigger condition descriptions 114. A trigger condition description, as utilized herein, defines criteria that initiate the execution of a customization sequence. Without limitation to any other aspect of the present disclosure, trigger condition descriptions may incorporate multiple types of conditions, complex logical relationships between conditions, and sophisticated evaluation rules to determine when a sequence should be executed.

Example and non-limiting trigger conditions 102 include: environmental conditions 106 (e.g., temperature thresholds, precipitation detection, ambient light levels, humidity, air quality measurements), location-based conditions 108 (e.g., geographic position, jurisdictional position, altitude, proximity to landmarks, parking structure entry/exit, home/work location detection), and/or time-based conditions 110 (e.g., specific times of day, calendar dates, day-of-week patterns, season-Attorney based triggers, duration-based conditions). Example environmental conditions 106 include a vehicle operating condition of any type, for example and without limitation: a vehicle state (e.g., idle, start-up, shutdown, in motion, operating on cruise control, in gear status, driving on operator control, etc.); a vehicle operational status (e.g., speed, direction, acceleration, turning, current gear, a relevant diagnostic or fault status, etc.); a categorical location (e.g., highway, city street, parking lot, driveway, etc.); a trip status (e.g., progression on the trip, operating time, remaining trip time, planned route compliance, etc.); and/or a state of any sensor and/or actuator on the vehicle (e.g., window position, wiper status, light status, infotainment status, HVAC status, etc.).

In certain embodiments, trigger conditions encompass comprehensive state-based evaluations across multiple vehicle systems and parameters. The system further considers occupancy states, determining the presence and position of drivers and passengers. System states encompassing door positions, window positions, and other physical configurations provide additional trigger criteria. Network connectivity states, including phone connections and home network detection, enable connectivity-based triggers. User states, including specific user identities and their associated preferences, allow for personalized trigger conditions.

Trigger conditions may incorporate specific data processing requirements to ensure robust and reliable evaluation. Trigger conditions may define filtering parameters and averaging periods to eliminate noise and spurious inputs. In one example, trigger conditions may include threshold hysteresis and debounce timing to prevent oscillation around trigger points.

The trigger condition description 114 may include error management and validation frameworks. Trigger conditions may include timeout parameters to prevent indefinite waiting states. Trigger conditions may include fallback conditions to provide graceful degradation when primary triggers cannot be evaluated.

Trigger conditions may include a hierarchical structure that provides precedence and evaluation paths. Trigger conditions may include primary conditions configured to serve as fundamental prerequisites that must be satisfied before further evaluation proceeds. Trigger conditions may include secondary conditions structured to provide additional refinement once primary conditions are met.

Without limitation to any other aspect of the present disclosure, customization sequence descriptions 112 and/or trigger condition descriptions 114 may be specified in multiple formats and through various interfaces, enabling flexible sequence creation while maintaining precise execution control. The system supports multiple specification methods to accommodate different user capabilities and integration requirements. In certain embodiments, sequence descriptions may be specified through data structures including, but not limited to: JSON files, XML, domain-specific language (DSL) scripts, binary formats, and the like.

The interface circuit 118 receives and processes inputs for trigger descriptions 114 and sequence descriptions 112 through multiple channels and formats, providing a flexible architecture for sequence and trigger definition. In certain embodiments, the interface provides an interactive graphical user interface allowing users to construct trigger conditions through visual tools, such as condition builders with drag-and-drop capabilities, dropdown menus for selecting environmental parameters, time-based condition editors, and location selection tools utilizing map interfaces. The graphical interface may further include real-time validation feedback, suggesting compatible parameters and highlighting potential conflicts or invalid combinations during the trigger condition construction process. In embodiments, the interface supports structured data input formats for both trigger conditions and sequence descriptions. Users may submit definitions through file upload, API submission, or direct text entry in a development interface.

The system 100 includes sequence management circuit 120. The sequence management circuit may be configured to receive inputs from the interface circuit 118 and generate a trigger detection plan 124 and/or a sequence execution plan 122. The trigger detection plan 124 establishes protocols for monitoring and evaluating trigger conditions, while the sequence execution plan 122 defines the steps required to implement the customization sequence when triggered.

A trigger detection plan and sequence execution plan, as utilized herein, represent structured operational blueprints generated by the sequence management circuit in response to trigger condition descriptions and sequence descriptions, respectively. The trigger detection plan defines specific monitoring parameters, measurement thresholds, sampling requirements, and evaluation logic necessary for determining when trigger conditions are met. For example, a trigger detection plan generated from a temperature-based trigger condition would specify not only the temperature threshold but also the required sampling rate from relevant temperature sensors, any averaging or filtering requirements for the temperature data, and specific evaluation criteria such as how long the temperature must remain above or below the threshold to constitute a valid trigger event.

The sequence execution plan 122 establishes a comprehensive framework for implementing the customization sequence, including detailed mapping of sequence steps to specific vehicle end points, timing requirements between steps, resource allocations, and contingency pathways. The plan transforms high-level sequence descriptions into concrete execution instructions that account for vehicle-specific parameters and network architecture. For instance, a sequence execution plan for a morning comfort sequence might specify exact command parameters for seat position actuators, precise timing for climate control system activation, and specific messaging requirements for the vehicle network, while maintaining defined ordering dependencies between these operations.

The plans also include provisions for resource contention, defining how multiple triggers or sequences should interact when competing for the same vehicle resources. Both plans may accommodate real-time conditions and system states. The trigger detection plan may include adaptive thresholds that may adjust based on environmental conditions or system learning, while the sequence execution plan may incorporates conditional branches and fallback options that can modify sequence execution based on real-time feedback from vehicle systems. For example, the trigger detection plan might adjust sampling rates based on detected environmental stability, while the sequence execution plan could modify actuation timing based on current vehicle load conditions.

The sequence management circuit 120 may employ a multi-stage translation process to convert high-level trigger condition descriptions and customization sequence descriptions into executable trigger detection plans and sequence execution plans. Without limitation to any other aspect of the present disclosure, the sequence management circuit may first perform a parsing operation on the received descriptions, decomposing them into elements that can be mapped to vehicle-specific capabilities and resources. During this parsing stage, the circuit validates syntax, confirms parameter completeness, and creates an internal representation of the required operations and their relationships.

In embodiments, the sequence management circuit 120 may utilize a translation engine that maps abstract trigger conditions and sequence steps to specific vehicle parameters and capabilities. This translation process may involve determining specific end points required for trigger monitoring or sequence execution, identifying necessary data processing operations, establishing communication paths across vehicle networks, and/or generating timing specifications for all operations. For example, when translating a temperature-based trigger condition, the circuit identifies specific temperature sensors available on the vehicle network, determines optimal sampling rates based on sensor capabilities and network bandwidth, and generates specific message formats required for data collection from these sensors. Similarly, for sequence steps, the circuit maps abstract actions like “adjust seat position” to specific actuator commands with appropriate parameters and messaging protocols.

In certain embodiments, the sequence management circuit employs a resource analysis and allocation system that evaluates the requirements of trigger detection and sequence execution against available vehicle resources. This analysis considers factors such as network bandwidth, processing capacity, sensor availability, and actuator capabilities. The circuit generates resource allocation schemes that ensure reliable operation while preventing oversubscription of vehicle systems. When resource conflicts are identified, the circuit implements priority-based arbitration schemes. In embodiments, priority-based arbitration may include modifying sampling rates, adjusting execution timing, or establishing resource-sharing protocols to accommodate multiple concurrent operations.

In embodiments, the sequence management circuit may incorporate a verification and optimization stage during plan generation. This stage confirms that all generated plans are feasible within vehicle constraints, validates timing relationships, and verifies that safety requirements are maintained. The circuit may adjust plans to optimize resource utilization while maintaining required functionality. For example, combining similar trigger condition evaluations to reduce redundant sensor polling or coordinating sequence execution timing to minimize network congestion.

During plan generation, the sequence management circuit creates data structures that support efficient runtime execution. These structures may define sensor mappings, evaluation rules, action steps, target identifiers, completion criteria, and other operational parameters required for execution.

In embodiments, the sequence management circuit may be configured to maintain traceability between generated plans and original descriptions, enabling runtime validation that execution remains consistent with user intent. This traceability also supports dynamic updates to plans when descriptions are modified, allowing for efficient plan maintenance without complete regeneration. The sequence management circuit may cache frequently used plan components to optimize plan generation for common trigger conditions or sequence elements, while ensuring that cached components remain valid within current vehicle configurations and capabilities. In certain embodiments, traceability provides for a number of additional benefits, such as: allowing an administrator or service personnel to troubleshoot issues with customized operations; allowing designers, engineers, or relevant personnel to track utilization of resources to support customized operations; allowing for planning personnel to determine future capability for vehicle computing resources (e.g., processing power, memory, network utilization, planning for end point distribution on network zones, etc.) and/or future offerings for standard or optional features on vehicles.

The system 100 includes a sequence execution circuit 126. Without limitation to any other aspect of the present disclosure, the sequence execution circuit operates to translate detected trigger events and sequence execution plans into specific customization commands 128 suitable for implementation by vehicle end points 132. The sequence execution circuit 126 processes trigger event values 130 and accesses corresponding sequence execution plans 122 to determine precise command parameters, timing requirements, and execution dependencies for each required vehicle operation.

In embodiments, the sequence execution circuit 126 maintains active monitoring of trigger event values and implements a state-based execution model to track sequence progression. Upon detection of a valid trigger event value 130, the circuit accesses the corresponding sequence execution plan and begins translation of planned operations into specific network messages, actuator commands, and other vehicle control operations. The circuit ensures proper command sequencing according to dependencies defined in the execution plan while maintaining awareness of current vehicle state and operating conditions.

In certain embodiments, the sequence execution circuit 126 includes a command generation algorithms that account for vehicle-specific requirements such as message formatting, timing constraints, and network protocols. The sequence execution circuit may implements error handling and verification during command generation and transmission. Before issuing commands, the circuit verifies that target end points are available and capable of executing requested operations. The circuit monitors command execution progress and may adjust subsequent commands based on execution results or completion status. When execution errors or delays occur, the circuit implements appropriate error recovery procedures as defined in the sequence execution plan.

Command generation by the sequence execution circuit may include real-time resource management and coordination. The sequence execution circuit 126 may monitor system resource utilization during command execution and may adjust command timing or parameters to prevent resource conflicts or overload conditions. This includes coordination of network bandwidth usage, actuator scheduling, and/or processing resource allocation across vehicle systems.

In certain embodiments, the sequence execution circuit 126 implements adaptive command generation based on learned vehicle behaviors and execution patterns. The circuit may adjust command parameters or timing based on historical execution results while maintaining compliance with sequence execution plan requirements. For example, adaptive commands may be generated utilizing any permissible end points, applications, flows, features, or the like on the vehicle, with a few non-limiting examples including: providing a message to an operator related to a personal event (e.g., a birthday message, anniversary, notification of a holiday relevant to the operator, etc.); providing a message to an operator based on calendar date, time of day, day of the week, trip beginning and/or ending location, etc.); adjusting a configuration of the vehicle based on previous history (e.g., noting relevant circumstances where the operator typically adjusts a mirror, moves a seat, adjusts an infotainment setting, sets a relevant operating mode for the vehicle, etc., where the relevant circumstances can include any aspect available to the sequence execution circuit 126—such as calendar date, time of day, day of the week, trip beginning and/or ending location, ambient temperature, weather, operator activity such as order of vehicle engagement events such as door opening, seat positioning, starter engagement, keyswitch manipulation, etc.; where a message includes any action that may act as a communication to the user at least in some circumstances, such as an infotainment action, an internal lighting sequence, a generated sound, a display message, etc.); and/or adjusting a vehicle operating parameter (e.g., lights, cruise control settings and/or limitations, mirror positioning, HVAC settings, wiper settings, wheel and/or pedal positions, etc.).

The sequence execution circuit provides feedback to other system components regarding command execution status and results. This feedback enables coordinated system operation and supports the proper execution of complex sequences requiring interaction between multiple vehicle systems. The circuit may generate notifications or status updates to inform relevant system components about sequence progression, completion status, and/or execution errors.

Without limitation to any other aspect of the present disclosure, end points 132 of the vehicle network are structured to be responsive to customization commands 128, implementing vehicle responses that reflect both the original customization sequence description and current detected conditions. The end points may include actuators, controllers, sensors, or other vehicle components capable of implementing or supporting automated responses.

In some embodiments, when an end point receives a customization command, it may first validates the command against its current operational capabilities and state. The end point processes command parameters accounting for current detected conditions that may influence response implementation. For example, an HVAC system end point receiving a temperature adjustment command may modify its response based on current ambient conditions, while a seat positioning end point may adjust movement speed based on detected occupant presence and/or detected characteristics of the occupant (e.g., identity, height, weight, eye position, hand position, etc.). This condition-aware response mechanism ensures that automated vehicle responses remain appropriate and safe across varying operational conditions while maintaining compliance with the original sequence description intent.

System 100 may include prioritization parameters within the customization sequence description that establish precedence between driver and passenger comfort settings. Without limitation to any other aspect of the present disclosure, these prioritization parameters enable the system to differentially adjust settings such as climate control, seat positioning, or ambient conditions to favor driver comfort while maintaining acceptable passenger comfort levels. For example, when implementing climate control adjustments, the system may direct primary airflow to the driver's zone or adjust temperature settings to optimize driver comfort before addressing passenger zone conditions. These prioritization parameters ensure that driver comfort and safety are maintained as primary considerations while still providing appropriate comfort levels for passengers.

In certain embodiments, the interface circuit processes multiple customization sequence descriptions, each tailored to specific driving scenarios. These scenarios may include but are not limited to daily commuting, long-distance travel, urban navigation, school transportation, or recreational outings. Each customization sequence description contains specific parameters, ordering requirements, and trigger conditions appropriate for its associated driving scenario. The system maintains these multiple sequence descriptions independently while ensuring proper selection and execution based on detected driving conditions or user selections. This scenario-based organization enables optimal vehicle customization across varying driving conditions and use cases while maintaining consistent and appropriate vehicle responses for each specific situation.

Without limitation to any other aspect of the present disclosure, the interface circuit is structured to process conditional actions within customization sequence descriptions that are responsive to detected passenger characteristics including height, weight, or age parameters. The interface circuit interprets these conditional elements by parsing specific action modifications or branches that should occur when particular passenger characteristics are detected, creating a dynamic response framework that adapts vehicle settings based on occupant attributes.

The system processes passenger characteristics through various detection methods and sensors throughout the vehicle. Height detection may be implemented through seat or headrest position sensors, cabin imaging systems, or weight distribution patterns. Weight characteristics may be determined through seat pressure sensors or load cell measurements. Age characteristics may be inferred through a combination of detected physical parameters, user profiles, or direct input. These detected characteristics are evaluated against conditional thresholds or ranges specified within the customization sequence description to determine appropriate action modifications.

When implementing conditional actions, the system may adjust various vehicle parameters to accommodate detected passenger characteristics. For example, detecting a child passenger might trigger modified climate control settings for the rear seats, automatic engagement of child locks, or adjusted airbag deployment parameters. Detection of a tall passenger might initiate automatic adjustments to seat position, headrest height, or mirror angles. Weight detection might influence seat heating or cooling intensity, seat belt tension parameters, or suspension settings. These conditional actions ensure that vehicle responses are appropriately tailored to specific passenger characteristics while maintaining overall sequence coherence and safety parameters.

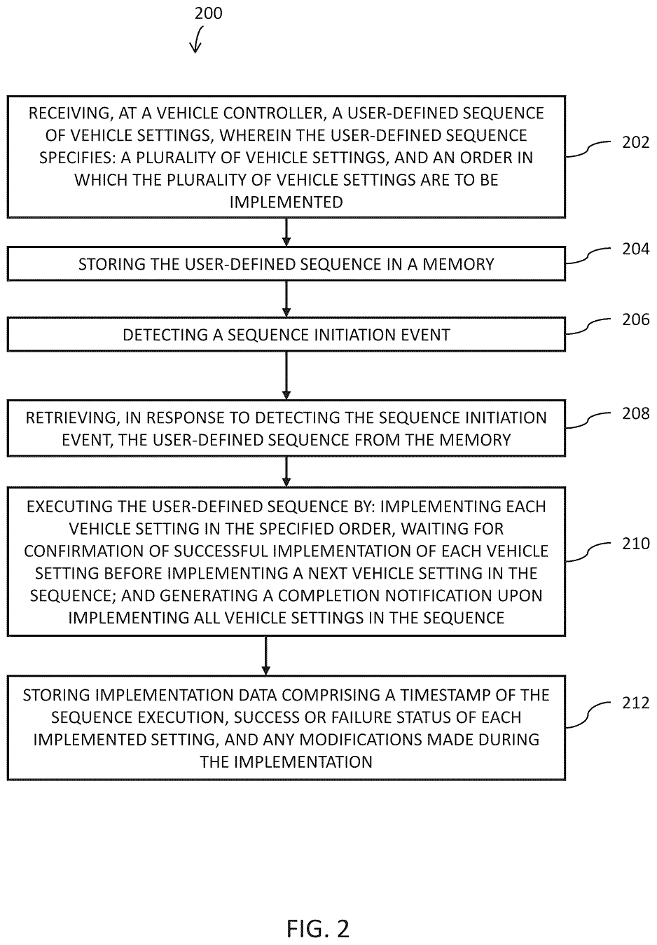

FIG. 2 depicts an example method 200 for implementing ordered vehicle personalization through precise execution of user-defined sequences. Without limitation to any other aspect of the present disclosure, at step 202 the method begins with receiving a user-defined sequence at a vehicle controller, where the sequence contains explicit specifications for both the vehicle settings to be adjusted and the order in which these adjustments must occur.

The user-defined sequence may be received through multiple interface channels and input mechanisms provided by the vehicle controller. The system supports sequence definition through an interactive graphical user interface that enables users to specify both settings and their implementation order through intuitive visual tools. This interface may include drag-and-drop functionality for ordering settings, parameter adjustment controls, and real-time validation feedback to ensure proper sequence construction. In embodiments, sequence templates and modification tools may be used. Users may select pre-defined sequence templates that can be customized through parameter adjustment and order modification. These templates provide starting points for common personalization scenarios. During sequence input, the interfaces provide real-time feedback regarding sequence validity and implementation feasibility. The system validates each setting specification and ordering requirement against vehicle capabilities, ensuring that received sequences can be properly implemented.

At step 204, the method includes operations to store the user-defined sequence in memory for subsequent access and execution. Upon detecting a sequence initiation event at step 206, which may include but is not limited to specific triggers such as vehicle entry, time-based conditions, or explicit user requests, the method, at step 208, retrieves the stored sequence from memory to begin execution.

As step 210, the method may include the execution phase. The execution includes implementing each vehicle setting according to the specified order, with the method enforcing a strict validation protocol between steps. After implementing each setting the method waits for explicit confirmation of successful implementation before proceeding to the next setting in the sequence. This confirmation requirement ensures proper completion of each step and maintains the integrity of the overall sequence execution. Upon successful implementation of all settings in the sequence, the method generates a completion notification to indicate full execution of the user-defined sequence.

In embodiments, at step 212, the method maintains comprehensive implementation records through detailed data storage operations. For each sequence execution, the method stores a timestamp of when the sequence was executed, along with detailed status information for each implemented setting. This status information includes both success and failure conditions for each setting adjustment, providing a record of the sequence execution results. Additionally, the method captures any modifications made during implementation, such as adjustments due to vehicle conditions or system constraints, ensuring a complete historical record of the sequence execution process.

In certain embodiments, when confirmation of successful implementation cannot be obtained for a particular setting, the method may implement recovery procedures, retry operations, or generate appropriate error notifications while maintaining the overall sequence integrity. These error handling mechanisms ensure reliable sequence execution while providing appropriate system responses to implementation issues.

In embodiments, the method supports dynamic sequence adjustment while maintaining proper ordering requirements. During implementation, the method may adjust specific setting parameters based on current vehicle conditions or system constraints while preserving the fundamental sequence order specified by the user.

Without limitation to any other aspect of the present disclosure, certain aspects of customization sequences incorporate mandatory ordering requirements that cannot be modified or overridden, particularly for sequences involving safety-critical operations or where specific ordering is essential to prevent potential harm to vehicle occupants. These protected sequence elements maintain strict ordering requirements regardless of user preferences or attempted modifications through interface inputs.

One example of a protected sequence order involves the relationship between seat position adjustments and steering wheel movements. The system enforces a mandatory “seat-first” ordering requirement where seat position adjustments should fully complete before any steering wheel position changes are initiated. This ordering requirement prevents potential occupant injury that could occur if the steering wheel were to adjust while the seat is in motion or before the occupant's final position is established. The system actively prevents any sequence modifications that would attempt to alter this ordering relationship.

The system may maintain a database of protected sequence relationships that cannot be modified through user inputs or interface operations. When processing sequence inputs or modification requests, the interface circuit actively identifies any protected sequence elements and ensures their ordering requirements remain intact. If a user attempts to create or modify a sequence that would violate these protected relationships, the system may automatically prevent the invalid modification while providing appropriate feedback regarding the mandatory ordering requirements.

Without limitation to any other aspect of the present disclosure, sequence execution may be modified by the system or a user. In one example, modifications may be performed in response to the presence of passengers. The system first detects the presence of a driver and two passengers, one adult in the front passenger seat and one child in the rear seat, through occupancy sensors, weight detection systems, and stored profile recognition. The system determines occupant characteristics, including driver identification through key fob association, adult passenger detection through weight and position sensors, and child passenger identification through weight patterns and a stored family profile.

Upon detection of this specific occupancy pattern, the system may modify the standard morning commute sequence to accommodate the determined occupant characteristics. The original sequence, which might typically prioritize uniform climate control settings, may be modified to create three distinct climate zones for each passenger.

The execution order of the modified sequence may be adjusted to prioritize certain operations based on occupant characteristics. The system first implements critical positioning adjustments (seat positions, mirrors, steering wheel) for the driver zone, followed by safety-related settings such as child lock activation and rear seat belt monitoring for the child passenger zone. The modified sequence may maintain special focus on the child passenger zone, implementing gentler temperature transitions and continuously monitoring comfort parameters.

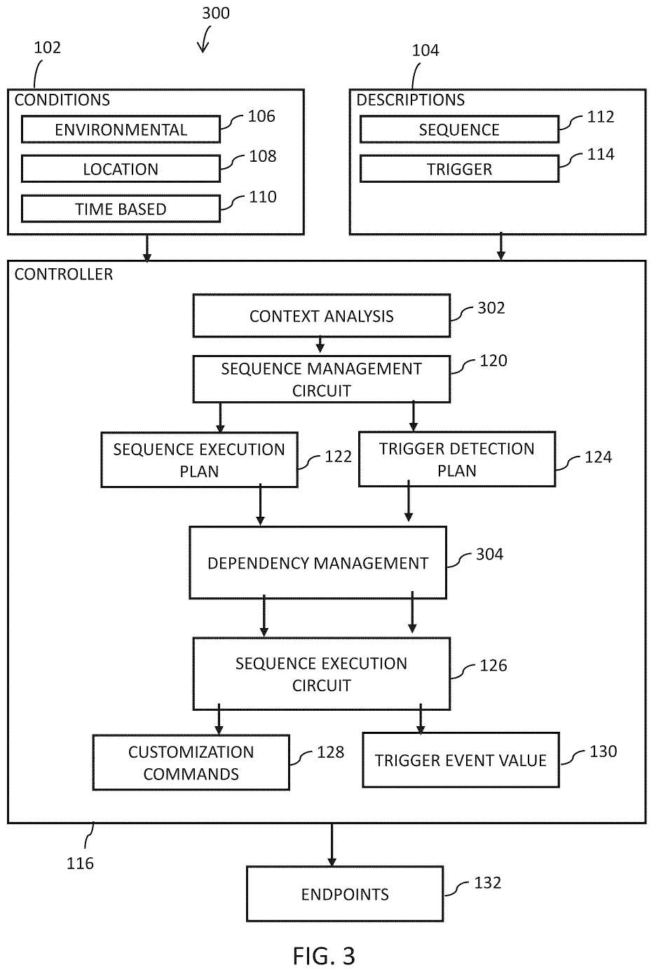

Referencing FIG. 3, an example system 300 for implementing automated vehicle configurations sequences in a vehicle is shown. The system may be configured to adjust an order of customization actions based on the dependencies between vehicle systems or operating requirements.

The system utilizes a network of vehicle endpoints coordinated by a controller 116 that analyzes driving context and environmental conditions to create and execute optimized action sequences. The system 300 may include a context analysis circuit configured to processes driving and environmental data to establish action priorities based on safety considerations, efficiency requirements, and user preferences.

Without limitation to any other aspect of the present disclosure, the context analysis circuit 302 may dynamically adjust the priority of personalization actions based on detected driving contexts and environmental conditions 106. For example, during a detected emergency maneuver or sudden weather change, the circuit may temporarily suspend or delay non-critical personalization actions such as seat heating adjustments or ambient lighting changes, prioritizing vehicle stability and safety-critical system responses. Once the emergency context is resolved, the circuit re-enables pending personalization actions according to their original specified sequence. In certain embodiment, dynamic adjustment of the priority of personalization actions may be based on environmental conditions 106, location-based conditions, time-based conditions 110, and/or a vehicle operating condition of any type.

In embodiments, the circuit may be configured to implement personalization priority adjustment based on driving scenarios. During highway driving, the system may prioritize driver-Attorney focused personalization actions such as seat position optimization for reduced fatigue, steering wheel position refinement, driver-zone climate control adjustments and the like. Conversely, during low-speed urban driving or when parked, the system may allocate higher priority to comfort-oriented personalization such as passenger climate preferences or entertainment system adjustments.

Environment-based priority adjustment enables intelligent sequencing of personalization actions. For instance, when high ambient temperatures are detected, the circuit elevates the priority of climate-related personalization actions, initiating seat cooling and climate control adjustments before less critical comfort settings. Similarly, in low-light conditions, the circuit may prioritize visibility-related personalization such as mirror adjustments and display brightness settings while temporarily reducing the priority of non-visibility-related comfort adjustments.

The context analysis circuit 302 actively modifies personalization priorities based on detected vehicle conditions and resource availability. During periods of high electrical system load, the circuit may adjust the timing of power-intensive personalization actions, sequencing them to prevent system overload while maintaining critical vehicle functions. The circuit considers factors such as battery state, charging status, and power consumption patterns when establishing personalization priorities, ensuring stable vehicle operation while maximizing comfort within available resources.

In certain embodiments, the context analysis circuit 302 may include a prediction of future contexts when establishing personalization priorities. For example, if the navigation system indicates an approaching highway segment, the circuit may prioritize driver-focused personalization before entering high-speed operation. This predictive priority adjustment ensures optimal configuration of personalization settings before encountering changed driving conditions, enhancing both safety and comfort through proactive system adjustment.

The system 300 includes a sequence management circuit 120 that transforms prioritized actions into ordered execution plans 122 based on the conditions 102. Working in conjunction with a dependency management circuit 304, the system may dynamically adjust action ordering to accommodate complex relationships between vehicle systems and operating requirements.

The sequence execution circuit 126 may implement the ordered action plan by communicating specific commands 128 to appropriate end points 132 throughout the vehicle network.

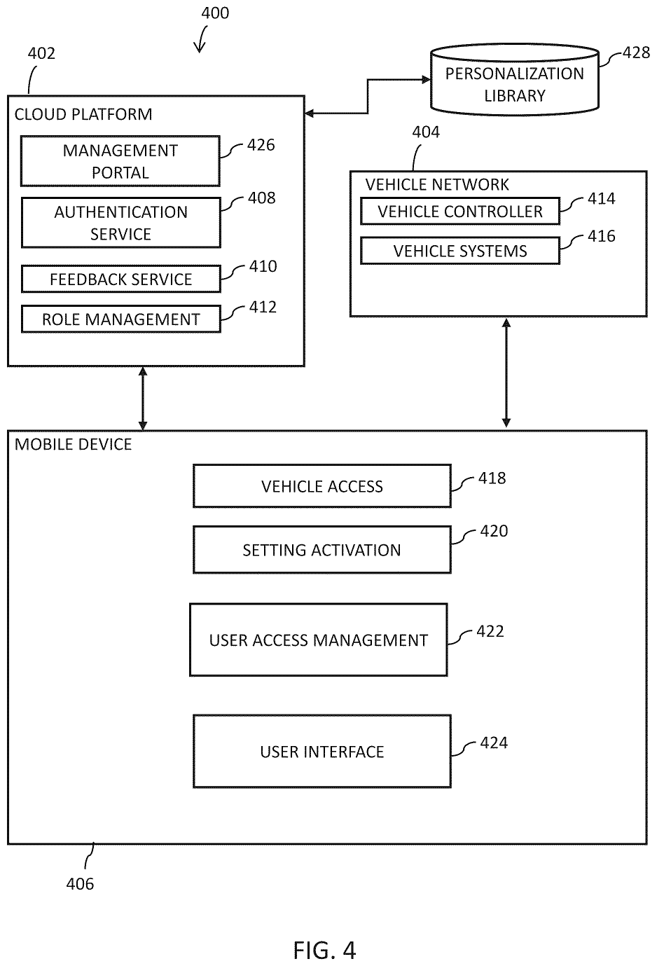

FIG. 4 is an example system 400 for remote vehicle personalization through a mobile device 406 operatively connected to a vehicle network 404. The example vehicle network 404 has one or more vehicle controllers 414 thereon, which may be embodied as one or more end points, and/or may be disposed on one or more end points. The example vehicle network 404 provides connectivity for one or more vehicle systems 416, which may be associated with end points of the vehicle in a many to many relationship. The mobile device implements a user interface 424 structured to enable activation and management of personalized vehicle settings through intuitive interaction elements. This interface provides organized access to available personalization options while maintaining appropriate security and authentication requirements for remote vehicle access.

The system 400 employs a vehicle access module 418 configured for authentication mechanisms to verify user identity and authorization prior to enabling personalization controls, for example exercised by an authentication service 408. The authentication process may incorporate multiple factors including device credentials, user login information, biometric data, and vehicle-specific security tokens.

Upon successful authentication, a settings activation module enables selective activation of personalized vehicle settings through the mobile device interface 424. The module presents available personalization options according to user authorization level and vehicle capabilities, allowing users to select and modify specific settings for remote activation.

The settings activation module 420 implements secure transmission protocols for communicating selected personalization settings from the mobile device 406 to the vehicle network 404. These transmissions utilize encrypted communications channels and verification mechanisms to ensure reliable and secure delivery of setting commands. The module maintains awareness of vehicle connectivity status and implements appropriate retry mechanisms when communication interruptions are detected.

The system 400 provides comprehensive feedback mechanisms regarding setting activation status, for example implemented by a feedback service 410. The settings activation module 420 monitors the application of transmitted settings and generates detailed status updates for display on the mobile device or cloud platform 402. These status notifications include confirmation of successful setting applications, identification of any failed settings, and relevant details about current vehicle configuration status.

A user access management module 422 is configured for role-based access control for vehicle settings. This module assigns differentiated access levels based on authenticated user roles, enabling granular control over available personalization options. For example, a primary user role may have full access to all vehicle settings, while secondary users may be restricted to specific comfort or entertainment settings without access to vehicle performance or security configurations.

The user access management module 422 maintains dynamic role assignments that can adapt based on vehicle context or operating conditions. The module may temporarily elevate or restrict access levels based on detected conditions, vehicle location, or specific usage scenarios. This dynamic access management ensures appropriate setting control while maintaining vehicle safety and operational integrity across varying usage conditions.

Without limitation to any other aspect of the present disclosure, the system, such as system 400, provides multiple secure methods for establishing connection and transmitting settings to a target vehicle. Users may initiate vehicle connection through smartphone-based QR code scanning of vehicle-specific identifiers, manual entry of secure passcodes displayed on vehicle interfaces, or direct VIN entry through mobile applications. Each connection method implements appropriate authentication protocols to ensure secure transmission while preventing unauthorized access to vehicle systems.

For QR code scanning, the system may generate dynamic, time-limited codes displayed on the vehicle's interface that encode encrypted vehicle identifiers and session-specific security tokens. The scanning process through a mobile device 406 to initiate a secure handshake protocol, validating both the device and user credentials while establishing an encrypted communication channel for settings transmission.

VIN-based authentication may employs enhanced security measures due to its non-proximity nature. The system 400 may require additional verification factors when establishing connections through VIN entry. These enhanced measures include user biometric verification on supported devices and secondary confirmation codes sent through registered communication channels. The system may perform validation against authorized user-vehicle relationships stored in secure cloud services.

For a successful authentication, the system establishes secure communication channels utilizing industry-standard encryption protocols. The communication channels can be used to provide customization descriptions to a vehicle. In some scenarios the customization descriptions may be a customization sequence descriptions and/or a personalization playlist.

The system enables comprehensive playlist creation and management through both mobile applications and cloud-based platforms. Users can create, modify, and organize multiple setting playlists through intuitive interfaces that provide access to all available personalization options. The remote activation capability enables users to initiate playlist implementation before vehicle entry, ensuring optimal vehicle configuration upon arrival. For example, a user might activate their “morning commute” playlist while approaching the vehicle, triggering systematic implementation of preferred settings including climate control, seat position, and drive mode configurations.

A customization playlist, as utilized in the present disclosure, should be understood broadly. A playlist may include an ordered collection of vehicle settings, preferences, and configurations that can be stored, transmitted, and implemented as a unified group. Without limitation to any other aspect of the present disclosure, a customization playlist may include both the specific setting values to be implemented and the conditions under which these settings should be applied. Each playlist may contain comprehensive vehicle personalization parameters including comfort settings, driving preferences, safety configurations, entertainment preferences, and interface customizations.

Customization playlists may include conditional elements that modify setting implementation based on detected conditions or contexts. These conditions may reference environmental factors, vehicle states, occupancy patterns, or temporal parameters. The playlist structure enables sophisticated branching logic that can adjust setting values or implementation sequences based on real-time evaluation of these conditions, ensuring appropriate customization across varying operational scenarios.

The system enables creation of multiple playlists for different scenarios or purposes, such as daily commute configurations, long-journey settings, or specialized driving conditions.

The system 400 enables granular control over playlist implementation when transferring settings to new vehicles. The system presents users with categorized setting groups, allowing selective activation based on usage context or duration. This selective activation is particularly relevant for temporary vehicle usage scenarios such as rentals or shared vehicles. When activating playlists in these contexts, users can choose to implement specific setting categories such as comfort preferences or driving modes while deliberately excluding personal configurations like entertainment preferences or long-term learning parameters.

In embodiments, the system 400 may generate feedback mechanisms during remote playlist activation. Users receive detailed status notifications indicating aspects such as successfully applied settings, settings pending implementation, settings skipped due to vehicle incompatibility, settings blocked by vehicle policies or constraints.

In certain embodiments, the system may provide compatibility analysis when transferring playlists between different vehicle types or models. Before initiating setting transmission, the system evaluates playlist contents against target vehicle capabilities, identifying compatible settings and flagging potential issues..

In embodiments, the system may maintain detailed logs of playlist transmission and implementation activities, enabling users to track setting activation across multiple vehicles or usage sessions. The logs may capture context information such as vehicle identification details, connection method utilized, settings selected for activation, and/or implementation results.

Without limitation to any other aspect of the present disclosure, fleet-wide personalization control may be implemented through a hierarchical settings management system and/or role management 412. Role management 412 may be configured to enable fleet administrators to define and enforce boundaries for automatic personalization. The system may be used to establish fleet-wide policies (e.g., specific rental cars, truck fleet, etc.) that specify which vehicle settings may be subject to automatic personalization, and/or allowable settings within the customizable parameters.

The system implements a multi-level settings that include restricted settings that cannot be personalized (e.g., vehicle performance limits, safety system parameters), administrator-approved settings eligible for controlled personalization (e.g., climate control ranges, seat position limits), freely personalizable settings available for full user customization (e.g., entertainment preferences, display configurations). Fleet administrators can establish bounded ranges or specific limits within which automatic personalization may occur. For example, an administrator might specify that seat positions can be automatically adjusted but must maintain minimum distances from vehicle controls, or that climate control settings can be personalized within defined temperature ranges.

In certain embodiments, the system implements role-based personalization limits within the fleet context. Different driver categories may receive varying levels of personalization authority based on factors such as experience level, vehicle type, or operational role. For instance, senior drivers might receive broader personalization capabilities while new drivers operate under more restricted personalization limits. In another example, car rental customers with a preferred status (e.g., a status earned by renting a threshold number of days per year) may be provided with broad personalization while a new customer may have a limited set of possible personalization.

### Personalization Patterns Across Vehicles

In embodiments, the system supports dynamic policy adjustment based on operational conditions or fleet requirements. Administrators, or logic in the system, can temporarily modify personalization boundaries in response to, weather conditions, operational demands, safety concerns, regulatory requirements, and/or the like.

Without limitation to any other aspect of the present disclosure, the methods and systems described herein may include adaptation of general settings to specific vehicles through a comprehensive conversion database that maintains detailed mappings between abstract setting concepts and vehicle-specific implementations. For example, a general setting for “sporty acceleration response” may be translated to specific throttle mapping parameters, transmission shift points, and stability control thresholds appropriate for each target vehicle's capabilities and control systems.

The conversion database maintains multi-dimensional mapping relationships that account for various vehicle characteristics and systems. Each general setting may map to multiple vehicle-specific parameters based on the target vehicle's architecture. For instance, a general “preferred driving position” setting maps differently across vehicles based on their specific seat adjustment capabilities, steering column ranges, and mirror positioning systems. The database maintains these complex relationships while preserving the intended user experience across different vehicle platforms.

When adapting settings to a specific vehicle, the system first analyzes the target vehicle's capabilities and available parameters. Through the conversion database, the system identifies appropriate mapping pathways that maintain functional equivalence while accounting for vehicle-specific limitations. For example, adapting a general climate comfort setting requires analysis of the target vehicle's HVAC system capabilities, available temperature zones, and air flow control options to determine appropriate parameter translations.

The system implements range normalization when converting between different vehicles'capabilities. When a source vehicle has broader adjustment ranges than a target vehicle, the system scales settings appropriately while maintaining relative positions within available ranges. Similarly, when targeting vehicles with expanded capabilities, the system intelligently interpolates settings to utilize the additional adjustment range while preserving the user's intent.

In certain embodiments, the conversion database includes vehicle-specific compensation factors that adjust for differences in system responses or characteristics. These compensation factors enable more precise translation of settings between vehicles with different operational characteristics. For instance, converting seat position settings between vehicles requires compensation for different seat track lengths, height ranges, and adjustment mechanisms to maintain equivalent user positioning.

The conversion database includes setting adaptation across different generations of vehicle technology. As vehicles evolve with new features and capabilities, the database maintains mapping relationships that bridge technological differences while preserving setting functionality. This generational adaptation ensures that personalization preferences remain effective even as vehicle systems advance and implement new control strategies.

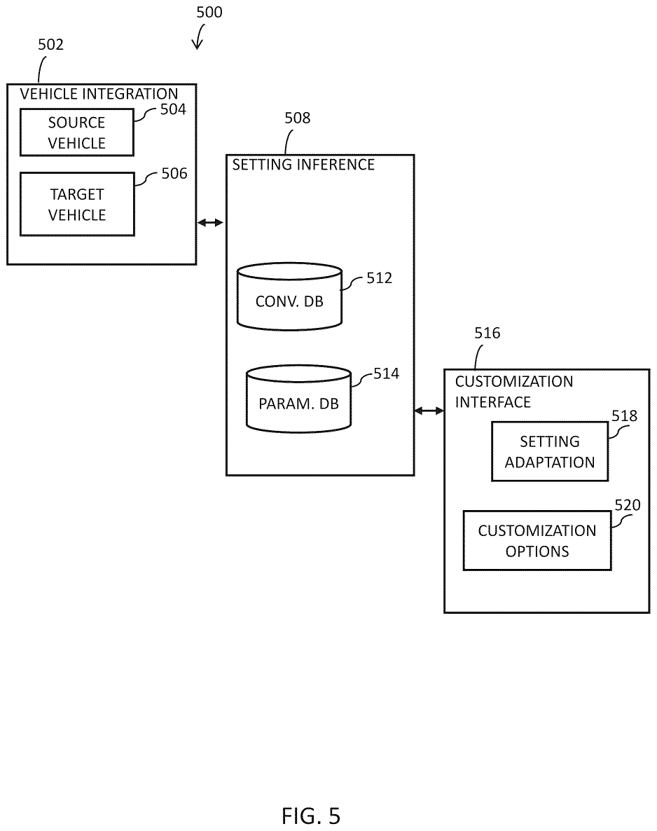

FIG. 5 is an example system 500 for implementing automated vehicle customization through a specialized application and inference framework. Without limitation to any other aspect of the present disclosure, the system comprises an application interface, for example embodied as a customization interface 516 in the example of FIG. 5, that enables users to create and manage both personalization profiles and setting playlists. This interface provides comprehensive tools for defining, organizing, and maintaining collections of vehicle settings that reflect user preferences and requirements across different vehicles and usage scenarios.

The system 500 includes a customization interface 516, operating with and/or within the application interface, that manages available personalization options based on vehicle capabilities. This customization interface dynamically presents appropriate setting options by analyzing vehicle characteristics (e.g., parameter database 514) and supported features, and/or permissions associated with the user. The available personalization options may be generated from a customized options 520 component, which can list available customizations, data, actuators, and/or interface with a library 428 to provide applicable formulated personalization features to be selected and/or utilized as a starting point for creating a new personalization feature.

An adaptation mechanism (e.g., setting adaptation 518) within the customization interface 516 can be configured to generate automatic adjustment of setting options based on vehicle model specifications. The adaptation process may include analysis of vehicle-specific capabilities, mapping of generic settings to vehicle-specific parameters, validation of setting ranges and limitations, and/or configuration of appropriate control interfaces.

The settings inference module 508 may include conversion logic that enables cross-vehicle setting translation. This module utilizes a comprehensive database of conversion settings 512 that captures relationships between different vehicle parameters and configurations. System 500 can translate settings from a source vehicle 504 (or a selected group of vehicles) to appropriate corresponding settings in a target vehicle 506 (or a selected group of vehicles), maintaining consistent personalization experiences across different vehicle types and models. An example system 500 includes a vehicle integration component 502 configured to access the source vehicle(s) 504, the destination vehicle(s) 506, and/or stored information (e.g., on the platform 402) corresponding to the vehicles 504, 506. The utilization of a source vehicle 504 is an optional capability, and personalization features can be created, additionally or alternatively, using a library 428 feature as a starting point, and/or creating a feature from scratch.

In embodiments, the system 500 may include profile merging capabilities that enable intelligent combination of settings from multiple vehicle setting profiles. Upon receiving a merge request, the system may initiate a comprehensive analysis process to identify all settings that overlap between the source profiles. This analysis may include pattern matching and/or functional equivalence and related settings that may interact or affect similar vehicle systems.

When overlapping settings are identified, the system evaluates multiple factors to establish appropriate resolution rules. These priority rules consider the operational context of each setting, their relationships to vehicle functions, and their impact on vehicle operation. For each overlapping setting, the system calculates weight factors based on multiple criteria. Frequency of user adjustments provides insight into setting importance through actual usage patterns, with more frequently adjusted settings receiving higher weighting. The system tracks setting modification recency, assigning greater weight to more recent changes as they likely reflect current user preferences. The system implements a comprehensive priority scoring mechanism that combines multiple weight factors into a unified priority assessment for each conflicting setting.

Profile merging proceeds through systematic evaluation and selection of settings. The system first incorporates all non-conflicting settings from source profiles, maintaining their original values and relationships. For conflicting settings, the system applies calculated priority scores to select appropriate values, with higher-scoring settings taking precedence. Throughout this process, the system maintains validation against vehicle-specific parameters to ensure all selected settings remain within acceptable operational ranges.

Without limitation to any other aspect of the present disclosure, the system implements secure settings sharing capabilities. Upon receiving a sharing request from a first user, the system initiates a comprehensive verification process examining the first user's sharing permissions and profile authorization levels. These permissions define which settings categories may be shared and establish boundaries for sharing operations while maintaining appropriate security controls.

The system may include data filtering during shareable package generation to protect sensitive information. This filtering process systematically identifies and removes all personal identification data, including but not limited to user identifiers, location histories, learned behavior patterns, and personalized labels. The system implements comprehensive scanning to identify and remove vehicle-specific secure parameters such as security codes, authentication tokens, paired device information, and access credentials. This removal process ensures that security-sensitive vehicle configurations remain protected while enabling sharing of general setting preferences.

The system performs format conversion to create platform-independent setting representations. This conversion process transforms vehicle-specific setting formats into standardized representations that maintain setting functionality while enabling cross-platform compatibility. The conversion maintains setting relationships and dependencies while removing platform-specific implementation details, ensuring that shared settings remain functionally equivalent across different vehicle systems.

Without limitation to any other aspect of the present disclosure, the system provides sophisticated real-time capture and management of vehicle customization settings through direct monitoring of physical vehicle controls. The system establishes secure communication links with vehicle control systems, enabling continuous observation of setting adjustments made through physical interfaces such as buttons, knobs, switches, and touch controls within the vehicle. This direct monitoring capability ensures accurate capture of user preferences as they are naturally expressed through normal vehicle interaction.

The system implements advanced real-time monitoring of vehicle setting inputs, maintaining continuous awareness of adjustments made through physical controls. When a user adjusts any vehicle setting through physical interfaces, the system detects these changes and initiates comprehensive data capture operations. Upon detecting setting changes, the system performs data capture operations recording multiple aspects of each adjustment. The system generates unique identifiers for each adjusted setting, establishing clear relationships between physical controls and their corresponding vehicle functions. The system captures setting values, maintaining appropriate resolution and units for each parameter type. Each adjustment is timestamped with high-precision timing information, enabling detailed temporal analysis of setting patterns.

The system provides visual feedback through a user interface that displays real-time setting adjustments. This interface presents clear visual indicators showing which settings have been modified, alongside precise current values for all adjusted parameters. The interface maintains synchronization with physical control inputs, ensuring accurate representation of vehicle configuration state.

The interface implements comprehensive management options for adjusted settings, presenting users with context-appropriate choices for handling captured adjustments. These management options enable users to control how captured settings are processed and stored, maintaining user control over profile generation while ensuring appropriate organization of captured preferences.

Based on user management selections, the system generates setting profiles that incorporate captured adjustment data.

An example personalization feature, function, routine, and/or playlist is captured and applied as a policy (and/or portion thereof), which may be created and/or deployed to the vehicle from outside the vehicle (e.g., a mobile application, web portal, proprietary program that communicates with the vehicle and/or with a cloud application that communicates with the vehicle, etc.), or from inside the vehicle (e.g., utilizing a console, dashboard, or display within the vehicle, and/or using a mobile device while positioned within the vehicle). In certain embodiments, the example personalization feature, function, routine, and/or playlist is applied and executed without an update to the software of the vehicle (e.g., using the policy and/or a data file implemented by an automation routine, such as set forth in U.S. application Ser. No. 17/833,614), allowing for a significant expansion in the set of users capable to implement a personalization routine, allowing for robust control of affected systems and/or security of the vehicle, and/or allowing for customization to a broad range of aspects of the vehicle without requiring certification procedures.

An example system includes a management portal 426 (e.g., reference FIG. 4) allowing an appropriate user (e.g., an owner, manufacturer, supplier, OEM, body builder, fleet owner, service personnel, dealer, aftermarket provider, etc.) to create, modify, deploy, monitor, amend, and/or remove personalization features and/or aspects thereof as set forth throughout the present disclosure, for example including at least aspects such as: sequence execution plan(s), trigger detection plan(s), customization command(s), and/or dependency management. In certain embodiments, the management portal, in whole or part, is positioned on, or in communication with, the cloud platform and/or a computing device associated with the appropriate user accessing the system with the management portal.

In certain embodiments, the system includes a library 428 of user defined trigger events, actions, and/or sequences of actions, which may be accessed by a user to create new personalization features, as a starting point for creating a personalization feature, and/or to store a personalization features as a new library element available to the user or other users. In certain embodiments, the library may be created, populated, and/or modified by operations of an appropriate user on the management portal. The example personalization library 428 may be positioned on the cloud platform 402 and/or in communication with the cloud platform 402. In certain embodiments, the personalization library 428 may be scoped, with one or more library elements visible to and/or accessible to particular personnel, with the scope of the particular personnel including a group such as: all users of the platform 402; users associated with a particular entity (e.g., a manufacturer, supplier, OEM, body builder, fleet owner, aftermarket provider, etc.); users associated with a particular role (e.g., owners, service, manufacturers, operators, etc.); users associated with a related group of vehicles (e.g., a fleet, a vehicle model, a specific manufacturer, a class of vehicles, vehicles having a particular role (e.g., passenger, commercial, trucks, emergency vehicles, government vehicles, etc.); and/or users related in any dimension of interest (e.g., residential location, related jurisdiction, a demographic value, etc.).

In certain embodiments, the management portal 426 performs validation of the personalization feature as it is being created and/or updated, for example ensuring that actions and/or data involved are permissible to the user, available on the target vehicle(s), and/or would not exceed an available resource limitation to support (e.g., processor execution cycles, network utilization, memory utilization, extra-vehicle communications limitations, etc.). In certain embodiments, the management portal 426 includes an interface to deploy a personalization feature to a selected group of vehicles, and/or to deploy a personalization feature to a library 428 accessible to a selected group of users.

In certain embodiments, the management portal 426 includes capability for a user to set access controls for a personalization feature, for a selected group of vehicles, for a selected group of users, for a selected user role, for selected entities, or the like. The access controls may include limitations scoped according to one or more of: specific data values or types of data; specific flows, features, applications, functions, or end points (and/or types or classes of these); and/or specific actions or types of actions. The access controls may include substantive limitations such as: resource utilization of a personalization feature; data that can be viewed, collected, and/or acted upon; and/or actions that can be performed. In certain embodiments, the access controls may be associated with a group of personalization features, for example to limit the aggregated resource utilization of personalization features on a particular vehicle.

In certain embodiments, the management portal 426 is accessed using a computing device, where the management portal 426 implements a user interface on the computing device to allow the user to perform operations thereon, including any operations of a management portal 426 as set forth herein, including library functions, access control functions, deployment functions, monitoring functions, and the like. The computing device to access the management portal 426 may be any type of device, for example a mobile device utilizing a mobile application, a personal computer accessing a web portal, a computing device operating a proprietary software program, or the like. In certain embodiments, the management portal 426 is accessible using an application programming interface (API), where a user can set up any user facing interface and accessibility method as desired, and exercising the functions of the management portal 426 utilizing the API.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor, or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die)

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM, and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon.

Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A system for automated vehicle configuration, comprising:
a vehicle having a network comprising a plurality of end points;
a controller, comprising:
a context analysis circuit structured to interpret driving context data and environmental condition data, wherein the context analysis circuit is configured to determine a prioritized sequence of actions based at least on one of safety, efficiency, or user-defined preferences;
a sequence management circuit structured to generate an ordered action plan in response to the prioritized sequence of actions, wherein the ordered action plan arranges the actions based on current driving conditions;
a dependency management circuit structured to dynamically adjust an order of actions in the ordered action plan based on dependencies between vehicle systems or operating requirements; and
a sequence execution circuit structured to execute the ordered action plan by sending action commands to one or more of the plurality of end points, wherein an order of the prioritized sequence of actions is automatically adjusted based on detected conditions.

2. The system of claim 1, wherein the sequence execution circuit is further structured to adjust the order based detection of at least one of nighttime driving or icy road conditions.

3. The system of claim 1, wherein the context analysis circuit further comprises a sensor interface configured to receive input from sensors detecting external lighting, road surface conditions, traffic, and weather.

4. The system of claim 1, wherein the sequence management circuit is further structured to prioritize actions that enhance visibility by at least one of activating adaptive headlights or adjusting dashboard lighting.

5. The system of claim 1, wherein the dependency management circuit is configured to detect interdependencies among vehicle systems.

6. The system of claim 1, wherein the context analysis circuit is further structured to incorporate user-defined preferences for non-critical.

7. The system of claim 1, wherein the dependency management circuit reorders actions in the ordered action plan to ensure that actions related to vehicle stability and control are executed before in-cabin settings.

8. The system of claim 1, wherein the sequence execution circuit is further configured to delay or modify the execution of actions based prioritizing actions that optimize fuel efficiency during congested driving conditions.

9. The system of claim 1, wherein the context analysis circuit includes a geolocation interface configured to adjust the prioritized sequence of actions when the vehicle enters school zones or construction areas.

10. The system of claim 1, wherein the sequence management circuit is further structured to automatically update the ordered action plan based on real-time data from external data sources.

11. A method for automated vehicle configuration, comprising:
receiving, at a vehicle controller, driving context data and environmental condition data;
determining a prioritized sequence of actions based at least on one of safety, efficiency, or user-defined preferences;
generating an ordered action plan in response to the prioritized sequence of actions, wherein the ordered action plan arranges the actions based on current driving conditions;
dynamically adjusting an order of actions in the ordered action plan based on dependencies between vehicle systems or operating requirements; and
executing the ordered action plan by sending action commands to one or more end points of a vehicle network, wherein the order of the prioritized sequence of actions is automatically adjusted based on detected conditions.

12. The method of claim 11, further comprising:
detecting at least one of nighttime driving or icy road conditions; and
adjusting the order of actions in the ordered action plan to prioritize safety-related actions in response to the detected condition.

13. The method of claim 11, further comprising:
receiving sensor input from at least one of external lighting sensors, road surface condition sensors, traffic sensors, or weather sensors, and
updating the prioritized sequence of actions based on the received sensor input.

14. The method of claim 11, further comprising:
prioritizing actions that enhance visibility by at least one of activating adaptive headlights or adjusting dashboard lighting.

15. The method of claim 11, further comprising:
detecting interdependencies among vehicle systems, and
reordering actions in the ordered action plan prioritize actions related to vehicle stability and control ahead of in-cabin settings.

16. The method of claim 11, further comprising:
incorporating user-defined preferences for non-critical actions into the prioritized sequence of actions.

17. The method of claim 11, further comprising:
delaying the execution of actions to prioritize actions that optimize fuel efficiency.

18. The method of claim 11, further comprising:
adjusting the prioritized sequence of actions when a vehicle enters a predefined geographic area.

19. The method of claim 11, further comprising:
Updating the ordered action plan based on real-time data received from external data sources.
